(19) United States
(12) Patent Application Publication
(10) Pub. No.: US 2005/0282504 A1
(43) Pub. Date: Dec. 22, 2005

(54) Apparatus for monitoring and recording audio and video

(76) Inventor: Ming-Hsiang Yeh, Taipei City (TW)

Correspondence Address: TROXELL LAW OFFICE PLLC, SUITE 1404, 5205 LEESBURG PIKE, FALLS CHURCH, VA, 22041, US

(21) Appl. No.: 10/871,060

(22) Filed: Jun. 21, 2004

(51) Int. Cl. H04N 17/00; H04N 17/02

(52) U.S. Cl. 455/90.1; 455/569.2; 455/575.9

(57) ABSTRACT

An apparatus for monitoring and recording audio and video is disclosed. The apparatus of the present invention is set on a car, house, or specific location to capture image of any angle by an image capture device located thereon. The image is then transmitted to a main machine located inside the car or the house. The main machine is able to record and show image and voice for monitoring so that if an accident occurred the accident cause can be ascertained by the help of the main machine to restore the moment of occurring accident. The main machine can be demounted to provide with various and convenient utilizations. The main machine is connected to the base, in which a reading unit and a memory socket are located thereon, through a transmitting interface for reading and storing data in the memory card. The stored data can be shown by using other electronic apparatuses. A charging circuit is set on the base, so that the main machine is charged through the base.

### FIELD OF THE INVENTION

The present invention relates to an apparatus for monitoring and recording audio and video, and more particularly, to an apparatus applied to a car, house, or specific location for recording surrounding image and voice any time to provide with various utilizations.

### BACKGROUND OF THE INVENTION

Traffic accident cannot be avoided completely due to all kinds of factor, such as human, weather, or some thing else, even the prohibition against drunken driving is adopted by the government to prevent from traffic accident. Once traffic accident occurred the scene was frequently disordered. If the overall evidence is not gathered immediately, it is hard to identify accident cause without witness's description of what he had seen. However, not every accident has witness. If both parties have no common view or the troublemaker has been left stealthily, it will be much more difficult to bring to light the truth and to ascertain accident cause and accident responsibility. Accordingly, it is needed to provide with an apparatus that is capable of recording audio and video of drive.

In addition, even the police came to the scene to gather evidence, it was still unfavorable for accident ascertainment without obtaining status of that moment of occurring accident. Other conventional apparatus fixed on an immobile position of the car cannot be used separately to enhance auxiliary recording capability and is not yet perfect. Moreover, in the conventional apparatus the recorded data is stored in a large-sized hard disk, which is not compatible with other electronic apparatuses for reading or other processing. Therefore, the utilization of the conventional apparatus is less convenient and does not satisfy the Actual Demand of user.

### SUMMARY OF THE INVENTION

One aspect of the present invention is to provide an apparatus for monitoring and recording audio and video, which is set on the car to capture image and voice for real-time recording driving status. If a traffic accident occurred, the driving status recorded by the present invention can be used as evidence to assist in investigating the accident cause. In addition, the main machine can be used separately to provide with auxiliary recording and various utilizations.

Another aspect of the present invention is to provide an apparatus for monitoring and recording audio and video, in which the acquired audio and video data is stored in the memory card and can be taken out for reading by computer or other electronic apparatuses. The main machine is put in a rechargeable base, in which a card-reading device is located thereon for reading/showing external data so as to supply with more convenient utilization.

Still another aspect of the present invention is to provide an apparatus for monitoring and recording audio and video, in which the video and audio data is wireless transmitted or received to provide with better utilization.

Still another aspect of the present invention is to provide an apparatus for monitoring and recording audio and video, which is connected to a global position system to enable the driver to recognize his location.

According to the aforementioned aspect of the present invention, there is provided an apparatus which comprises an image capture device, a main machine, and a base, the image capture device is set on a proper site which is inside/outside the car (or other specific locations) to acquire internal and external images in front and back of any angle of the car, the acquired image is transmitted to the main machine for image processing. The image capture device can be connected to the base so as to transmit the acquired image to the main machine through a transmitting interface.

The main machine comprises: an audio and video control unit used as a central control processor of audio and video signals; at least one image capture unit connected to the audio and video control unit for capturing image which is transmitted to a image processing unit for digitalizing the image; an audio input unit connected to the audio and video control unit for inputting/recording audio signal; a storage unit connected to the audio and video control unit for recording image and voice data, the storage unit can be a socket and plug type memory card; a display unit connected to the audio and video control unit for showing the processed image; an audio output unit connected to the audio and video control unit for showing voice or music; and a first transmitting interface for connection between the base and the main machine to transmit signal and to supply power for charging the main machine.

The base for supporting the main machine is connected to the first transmitting interface of the main machine by a second transmitting interface. A reading unit having a socket for a memory card is set in the front of the base for reading data in the memory card and transmitting the data to the main machine through the second transmitting interface. The audio and video data in the main machine can be transmitted to the base through the second transmitting interface for storing the data in the memory card by using the reading unit to read the data. A charging circuit is set on the base. The charging circuit is connected to a power cord and the other end of the power code is connected to a charging plug that is a vehicle charger plug for charging the main machine through the transmitting interface by the cigarette lighter on the car.

A wireless transmitting unit is located on the base. The audio and video data in the main machine can be transmitted to the base through the first transmitting interface and second transmitting interface of the base to be further transmitted to a remote mobile phone, computer, or other apparatuses by using the wireless transmitting unit. Accordingly, the real time status of the car is transmitted outwardly for notifying the remote apparatus or being stored. In addition, data transmitted from remote site can be received by the wireless transmitting unit and read by the main machine through the transmitting interface to accomplish the two-way transmission

A receiving unit of the global position system can be set on the base for receiving positional information that is transmitted through the satellite so as to enable the driver to recognize his location.

The foregoing aspects and many of the attendant advantages of this invention will become more readily appreciated as the same becomes better understood by reference to the following detailed description, when taken in conjunction with the accompanying drawings.

### BRIEF DESCRIPTION OF THE DRAWINGS

FIG. 1 is a block diagram of the present invention.

FIG. 2 is a schematic diagram showing outward appearance of the combined main machine and base in accordance with the present invention.

FIG. 3 is a schematic diagram showing a transmitting interface for connecting the main machine and the base in accordance with the present invention.

FIG. 4 is a schematic showing the use of the main machine and the base on the car in accordance with the present invention.

FIG. 5 is a schematic diagram showing the placement of the image capture device in accordance with the present invention.

FIG. 6 is a schematic diagram showing the placement of the image capture device in accordance with the present invention.

FIG. 7 is a block diagram showing the wireless transmitting unit and receiving unit of the global position system in accordance with the present invention.

### DETAILED DESCRIPTION OF THE PREFERRED EMBODIMENT

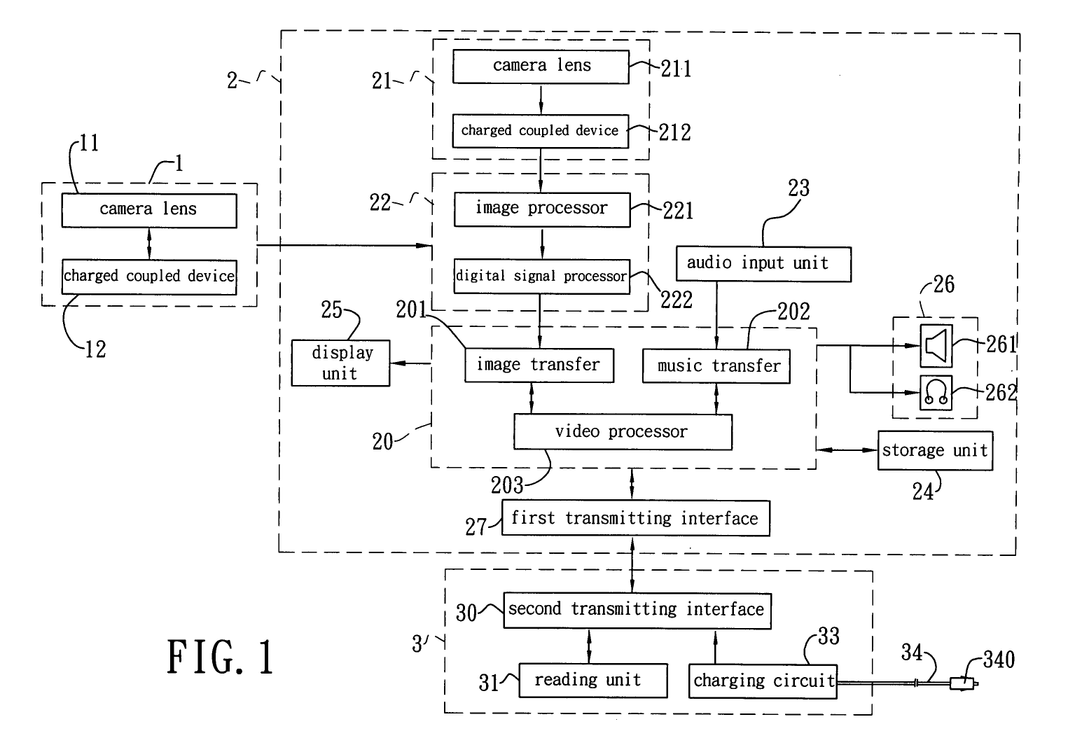

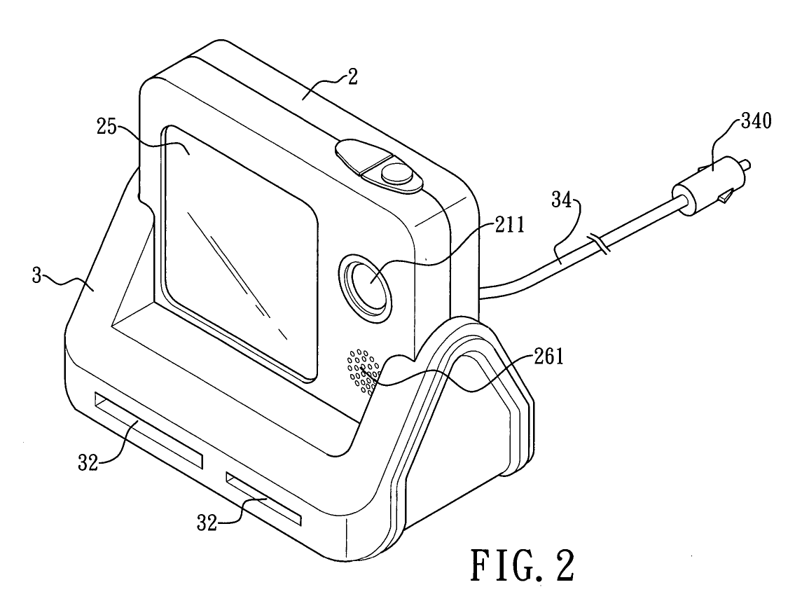

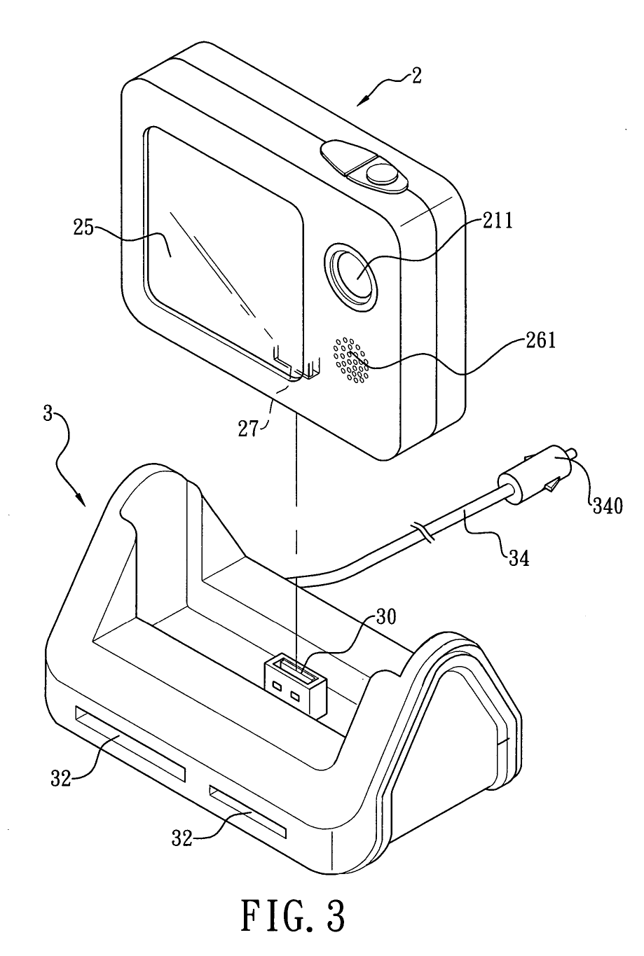

Referring to FIG. 1 to FIG. 3, which show a block diagram, a schematic diagram of outward appearance of the combined main machine and base, and a schematic diagram of a transmitting interface for connecting main machine and base. The apparatus of the present invention comprises an image capture device 1, a main machine 2, and a base 3. The image capture device 1 comprising a camera lens 11 and a charged coupled device (CCD) 12 is located on a proper site which is inside/outside the car to acquire internal and external image of any angle in front and back of the car. The image capture device 1 is connected to the main machine 2 for transmitting the acquired image to the main machine 2. Alternatively, the image capture device 1 can be connected to the base 3, and the image signal is transmitted to the main machine 2 through an interface by using the base 3.

The main machine 2 comprises the following:

An audio and video control unit 20, which is used as a central control processor of audio and video signal. The audio and video control unit 20 comprises an image transfer 201, a music transfer 202, and an audio and video processor 203, wherein the image transfer 201 and the music transfer 202 are used for converting analog/digital signal and transferring it to the audio and video processor 203 for performing the subsequent processing.

An image capture unit 21, which is connected to the audio and video control unit 20 for capturing image. The image capture unit 21 comprises at least one camera lens 211 which is preferably located on both a front side and a back side of the main machine 2 respectively for acquiring internal and external images in front and back of the car. The image capture unit further comprises a charged coupled device 212 connected to the camera lens 211 for capturing image and converting the image into a digital signal. The digital signal is then transmitted to an image processing unit 22 for image processing.

An image processing unit 22 for digitalizing the image, which is composed of an image processor 221 and a digital signal processor 222.

An audio input unit 23, which is connected to the audio and video control unit 20 for inputting audio signal and recording audio, wherein the audio input unit 23 can be a microphone, FM input, or other external audio input.

A storage unit 24, which is connected to the audio and video control unit 20 for recording image and voice data, wherein the storage unit 24 is a flash memory, such as a socket and plug type memory card.

A display unit 25, which is connected to the audio and video control unit 20 for showing the processed image.

An audio output unit 26, which is connected to the audio and video control unit 20 for showing audio, wherein the audio output unit 26 can be a speaker 261 or earphone 262.

A first transmitting interface 27, which is used as a connection between the main machine 2 and the base 3 to transmit signal, wherein the first transmitting interface 27, such as USB adapter, is an interface for charging the main machine by transmitting power.

The base 3 for supporting the main machine is connected to the first transmitting interface 27 of the main machine 2 by a second transmitting interface 30, such as an USB adapter. A reading unit 31 located on the base 3 is connected to the second transmit interface 30. A socket 32 for a memory card is set in front of the base 3 for reading data in the memory card. The data is then transferred to the main machine 2 for showing through the second transmitting interface 30. The memory card can be a memory stick (MS), smart media (SM), optical memory card, compact flash (CF), and secured digital (SD) card. The audio and video data in the main machine 2 is transmitted to the base 3 through the first transmitting interface 27 and the second transmitting media 30 for storing the data in the memory card by using the reading card 31.

A charging circuit 33 having one end connected to a power cord 34 is set on the base 3. The other end of the power cord 34 is connected to a charging plug 340 that is a vehicle charger plug for charging the main machine 2 through the second transmitting interface 30 and the first transmitting interface 27 by using the cigarette lighter on the car.

According to the above description, when the present invention is utilized, the image is acquired by the image capture device 1, which is located outside/inside the car, and the image capture unit 21, which is located on the main machine 2. The acquired image is then transmitted to the image processing unit 22 of the main machine 2 for digitalizing the images. After the audio and video control unit 20 converted the images, the converted images are shown on the display unit 25. The audio input unit 23 is used to acquire audio signal. The acquired audio signal is then converted by the audio and video control unit 20. The converted audio signal is then shown by using a speaker 261. Meanwhile, the captured image and the audio are recorded by the storage unit 24.

Therefore, a driving status of the car is obtained continuously as a reference for the driver. Also, if a traffic accident occurred, the continuous recording of audio and video that is stored in the storage unit 24 is helpful for accurate judging the accident cause and accident responsibility. In addition, the main machine 2 can be used separately. Thus, in the scene of accident the main machine 2 can be demounted from the base 3 for real-time recording the scene of accident so as to reserve evidence and to avoid the difficulty in gathering evidence after the scene of accident is destroyed. The recorded audio and video data is stored in the socket and plug type memory card, which can be taken out for reading by using a computer or other electronic apparatuses. Therefore, various and convenient data reading methods are therefore provided, instead of reading the data by the main machine merely.

Data stored in the external memory card can be read by the main machine 2 through the base 3 by inserting the memory card into the socket 32 located on the base 3 so as to enable the reading unit 31 to read the data. The data is then transferred to the audio and video control unit 20 of the main machine 2 through the second transmitting interface 30 and the first transmitting interface 27 followed by showing by the display unit 25 and the audio output unit 26. Thus, the present invention can be used as an audio and video recording apparatus for the drive as well as other situations. In addition, the present invention can be used as a data reading apparatus for a memory card to provide with various and convenient utilizations when driving out.

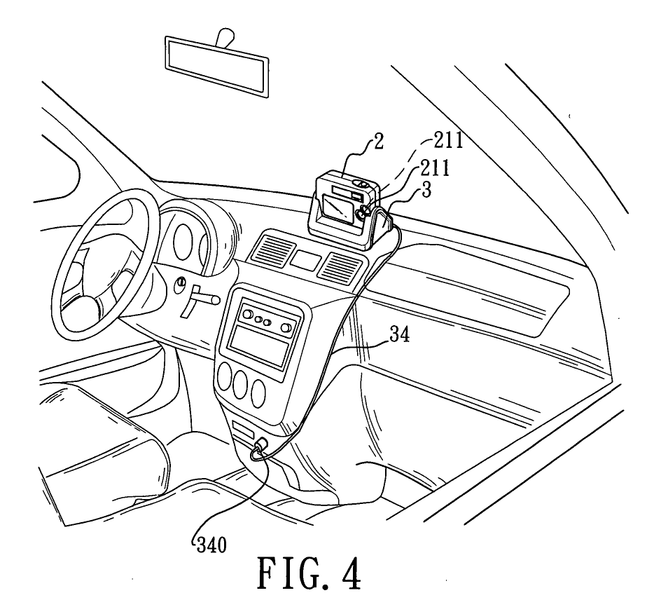

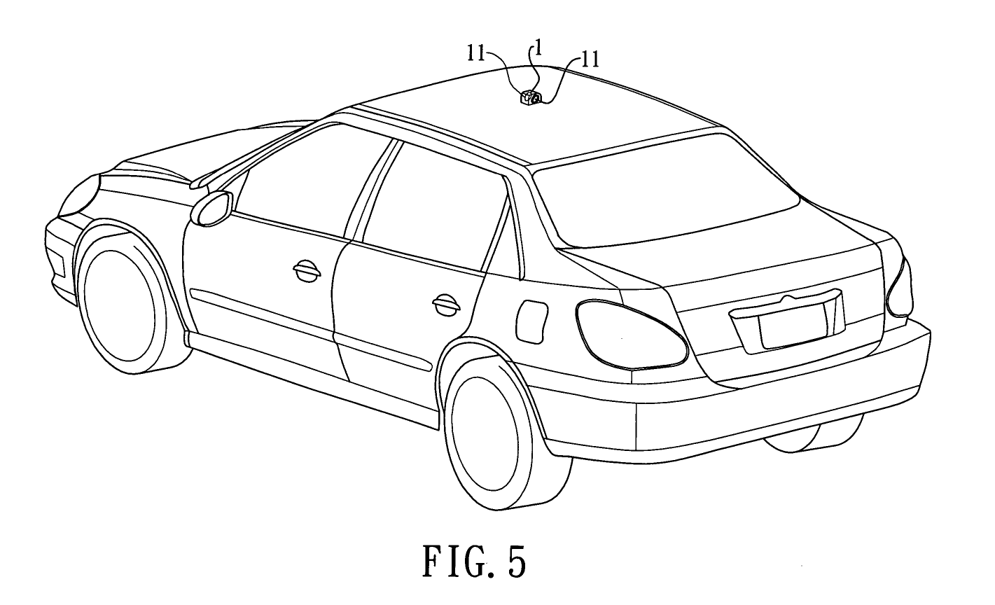

Please refer to FIG. 4 and FIG. 5, which are schematic diagrams showing the use of the main machine and the base on the car and the placement of the image capture device according to the present invention. In practical utilization of the present invention, the base 3 can be set in front of the front seat inside the car, the charging plug 340 is put in the cigarette lighter of the car, and the main machine 2 is put in the base 3 for enabling the camera lens 211 of which to acquire forward/backward image outside/inside the car. By controlling of the audio and video control unit one image frame is auto-captured with an interval of every 5 minutes, the captured image frame is then stored in the storage unit 24, wherein one of every five image frames has high image resolution. The image capture device 1 is set on the top of the car. Two sides of the car are equipped with a camera lens 11 respectively for acquiring images in front and back of the car. The acquired images are then transmitted to the main machine 2 that is set inside the car for image processing.

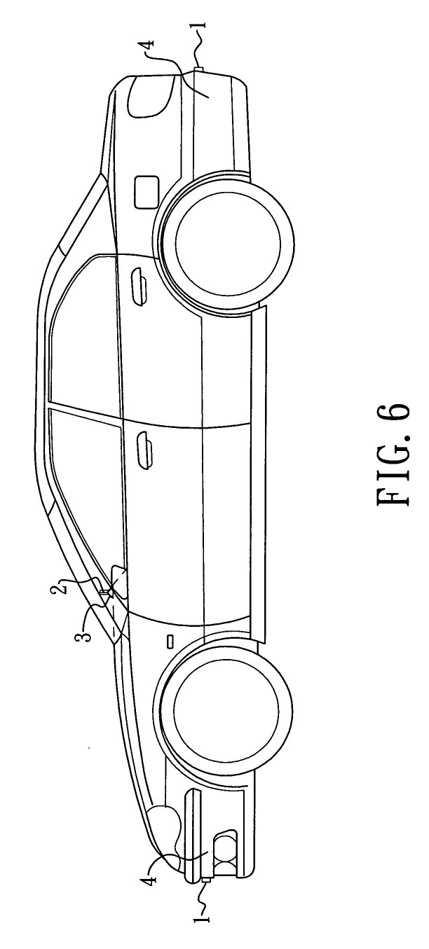

Please refer to FIG. 6, which is a schematic diagram showing the placement of the image capture device. The image capture device 1 can be set on the front bumper to acquire the front images 4 or on the back bumper 4 to acquire the back images in accordance with practical demand. In addition, the image capture device can be set on the left/right headlights, front/back turn lights, rearview mirror, or dashboard inside the car to acquire images of different angles.

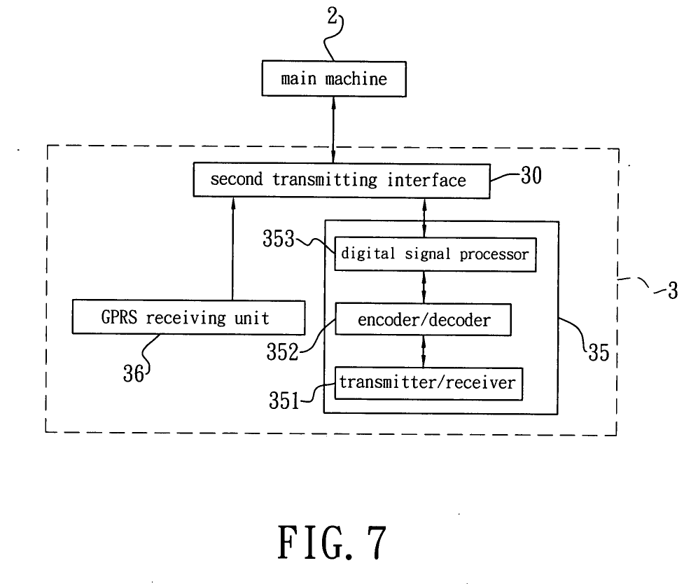

Please refer to FIG. 7, which is a block diagram showing the wireless transmitting unit and receiving unit of the global position system. A wireless transmitting unit 35, which comprises a transmitter/receiver 351, an encoder/decoder 352, and a digital signal processor 353, is set on the base 3. The audio and video data in the main machine 2 can be transmitted to the base 3 through the first transmitting interface 27 and second transmitting interface 30 of the base 3 to be further transmitted to a remote mobile phone, computer, or other apparatuses by using the wireless transmitting unit 35. Accordingly, the real time status of the car is transmitted outwardly for notifying the remote apparatus or being stored. The audio and video data is firstly processed by the digital signal processor 353 followed by being transmitted to the encoder/decoder 352 for encoding. Thereafter, it is transmitted by the transmitter/receiver 351. In addition, data transmitted from a remote site can be received by the transmitter/receiver 351. The received data is then restored by decoding of the decoder 352. Thereafter, the data is processed by the digital signal processor 353 followed by being transmitted to the main machine 2 through the second transmitting interface 30 to accomplish the two-way transmission. The wireless transmitting unit 35 can be made by Blue Tooth technique, general packet radio service (GPRS), or similar wireless transmitting technique.

A receiving unit 36 of the global position system can be set on the base 3 for receiving positional information that is transmitted through the satellite, therefore the driver can recognize his location.

Instead of on the car for recording driving status, the present invention can be set on other specific locations, such as outside/inside the house for monitoring and recording status of residence, office, storehouse, factory, or similar location to provide with widespread utilizations.

Therefore, as is understood by a person skilled in the art, the present invention achieves the aforementioned purpose according to the above description and satisfies requirements of patent law. The patent application is therefore submitted.

As is understood by a person skilled in the art, the foregoing preferred embodiments of the present invention are illustrated of the present invention rather than limiting of the present invention. It is intended that various modifications and similar arrangements be included within the spirit and scope of the appended claims, the scope of which should be accorded the broadest interpretation so as to encompass all such modifications and similar structure.

1. An apparatus for monitoring and recording audio and video, comprising: an image capture device, a main machine, and a base, the image capture device is used for capturing image of any angle of a site on which the apparatus is disposed, the image capture device is connected to the main machine so as to transmit the acquired image to the main machine for handling, wherein
the main machine comprises:
an audio and video control unit used as a central control processor of audio and video signals;
at least one image capture unit connected to the audio and video control unit for capturing the image;
image processing unit connected to the image capture unit for digitalizing the image and transmitting the image to the audio and video control unit;
an audio input unit connected to the audio and video control unit for inputting audio signal;
a storage unit connected to the audio and video control unit for recording image and voice data;
a display unit connected to the audio and video control unit for showing the processed image;
an audio output unit connected to the audio and video control unit for showing voice and music; and
a first transmitting interface for connecting the base to transmit signal;
the base for supporting the main machine is connected to the first transmitting interface of the main machine by a second transmitting interface, a reading unit connected to the second transmit interface is located on the base, a socket for a memory card is set in front of the base for reading data stored in the memory card and the audio and video data stored in the main machine; a charging circuit connected to the second transmitting interface is set on the base for charging the main machine.

2. The apparatus for monitoring and recording audio and video according to claim 1, wherein the image capture device is set outside/inside a car or a house, and the image capture device comprises a camera lens and a charged coupled device (CCD).

3. The apparatus for monitoring and recording audio and video according to claim 1, wherein the image capture device is also connected to the base for transmitting the image signal to the main machine through the second transmitting interface and the first transmitting interface.

4. The apparatus for monitoring and recording audio and video according to claim 1, wherein the audio and video control unit comprises an image transfer, a music transfer, and an audio and video processor, the image transfer and the music transfer are used for converting analog/digital signal and transferring the converted analog/digital signal to the audio and video processor.

5. The apparatus for monitoring and recording audio and video according to claim 1, wherein the image capture unit of the main machine comprises a camera lens which is located on both a front side and a back side of the main machine respectively for acquiring internal and external images in front and back of the car, the image capture unit further comprises a charged coupled device connected to the camera lens for capturing the image and transfer the image into a digital signal so that the digital signal is transmitted to the image processing unit for image processing.

6. The apparatus for monitoring and recording audio and video according to claim 1, wherein the image processing unit comprises an image processor and a digital signal processor.

7. The apparatus for monitoring and recording audio and video according to claim 1, wherein the storage unit is a flash memory, which is a socket and plug type memory card.

8. The apparatus for monitoring and recording audio and video according to claim 1, wherein the charging circuit is connected to a power cord and the other end of the power code is connected to a charging plug that is a vehicle charger plug for charging the main machine by the cigarette lighter on the car.

9. The apparatus for monitoring and recording audio and video according to claim 1, wherein a wireless transmitting unit connected to the second transmitting interface is located on the base, which comprises a transmitter/receiver, an encorder/decorder, and a digital signal processor, the transmitter/receiver is connected to the encorder/decorder, and the encorder/decorder is connected to the digital signal processor.

10. The apparatus for monitoring and recording audio and video according to claim 1, wherein a receiving unit of a global position system is set on the base.
